(19) United States
(12) Patent Application Publication
(10) Pub. No.: US 2026/0236083 A1
(43) Pub. Date: Aug. 13, 2026

(54) MACHINE LEARNING POWER MANAGER FOR WORKLOAD CLASSIFICATION AND POWER MANAGEMENT OPTIMIZATION

(71) Applicant: Google LLC, Mountain View, CA (US)

(72) Inventors: Shen-Hong Wang, New Taipei City (TW); Yu-Jin Yang, Hsinchu (TW); Hee jun Park, San Diego, CA (US)

(21) Appl. No.: 19/532,075

(22) Filed: Feb. 6, 2026

Related U.S. Application Data
(60) Provisional application No. 63/758,190, filed on Feb. 13, 2025.

(51) Int. Cl. G06F 1/3228

(52) U.S. Cl. CPC G06F 1/3228

(57) ABSTRACT

Methods and systems, including computer-readable media, are described for implementing a power manager that leverages machine learning for workload classification and fine-grained power management optimization. A computing system that includes the power manager obtains inputs generated by a performance counter of a system-on-chip coupled to the power manager. A workload type is determined by processing the inputs based on a clustering algorithm applied to the inputs using an ML classifier model of the power manager. A power hint is identified based on the workload type and using a data structure that maps workload types to power hints. For the determined workload type, power and performance policy settings are determined for a processor block of the system-on-chip based on the identified power hint.

### CLAIM OF PRIORITY

This application claims priority under 35 USC §119(e) to U.S. Patent Application Serial No. 63/758,190, filed on February 13, 2025, the entire contents of which are hereby incorporated by reference.

### BACKGROUND

This specification generally relates to power management of integrated circuits.

Modern computing systems often incorporate a wide variety of compute processing units that each offer different computing capabilities and tradeoffs. Efficient execution of computational workloads often involves parsing computations into meaningful tasks or subtasks that are mapped to available processor cores of a computing system. The computations may be parsed and mapped based on suitability criteria, such as processor capability, performance, and power. Generally, this overall process of allocating portions of a computation to appropriate processor resources is referred to as heterogeneous computing.

At least one processor core of the computing system can be an Intellectual Property block (“IP block”) that executes a respective portion of a computational operation for different multimedia use cases. Example multimedia use cases can involve processing image and video data captured by a multi-camera system of a mobile device such as a smartphone. A system-on-chip (“SoC”) of the device can use a heterogeneous computing operation to process input samples derived from the image/video data. An example step in the heterogeneous operation can include processing the image/video data and providing any outputs and related input samples to either an IP block or machine-learning engine, respectively, to generate a corresponding output, such as an image processing output that blends content from at least two images.

In the context of machine-learning (“ML”), neural networks employ one or more layers of nodes to generate an output, e.g., a classification, for a received input. Some neural networks include one or more hidden layers in addition to an output layer. The output of each hidden layer is used as input to one or more other layers in the network, e.g., other hidden layers or the output layer of the network. A layer of the neural network can generate an output from a received input in accordance with current values of a respective set of

parameters. Some neural networks can be convolutional neural networks (CNNs) configured for image and/or language processing, whereas other neural networks can have a transformer network architecture that is based on attention mechanisms, which could augment convolutional networks.

### SUMMARY

This specification describes techniques for implementing a power manager that leverages machine-learning (“ML”) algorithms to execute workload classification and fine-grained power management optimization at a SoC that includes one or more hardware integrated circuits. The ML power manager can be implemented as a kernel module of an operating system kernel that applies certain global power policies to enhance power and performance allocations of the SoC. The power manager includes a proactive, ML-based workload classifier that collects low-level system indices and determines workload types by classifying one or more existing workloads using a pre-trained ML classifier model. The ML power manager also includes a reinforcement learning model that adaptively determines and applies power policies based on the determined workload type(s).

One aspect of the subject matter described in this specification can be embodied in a method performed using a power manager that includes one or more neural network machine-learning (ML) models. The method includes: obtaining multiple inputs generated by a performance counter of a system-on-chip coupled to the power manager; determining, by an ML classifier model of the power manager, a workload type in response to processing the multiple inputs based on a clustering algorithm applied to the multiple inputs by the ML classifier model; identifying, based on the workload type, a power hint using a data structure that maps multiple workload types to multiple power hints; and determining, for the power hint, power & performance policy settings for a processor block of the system-on-chip.

These and other implementations can each optionally include one or more of the following features. For example, in some implementations, the method further includes: adjusting one or more system parameters based on the power & performance policy settings determined for the processor block of the system-on-chip. The method further includes: generating the data structure based on machine-learning computations executed by a reinforcement learning model of the power manager. The data structure maps the multiple workload types to the multiple power hints based on a reward function that optimizes respective power & performance policy settings for each of the multiple power hints. In some implementations, each of the multiple power hints is mapped to a corresponding set of power & performance policy settings that represent a global power policy for a corresponding workload type.

In some implementations, the clustering algorithm is an unsupervised K-means clustering algorithm, whereas in some other implementations the clustering algorithm is a supervised K-means clustering algorithm. The method further includes: i) training the ML classifier model based on a K-means clustering algorithm during a training phase of the ML classifier model; ii) identifying, during the training phase, multiple distinct patterns among multiple datasets that represent different workloads processed at a system-on-chip; and iii) generating, during the training phase, N clusters of workloads based on the identified multiple distinct patterns. Each cluster of the N clusters can include a respective subset of workloads that are among the different workloads represented by the multiple datasets.

In some implementations, the multiple inputs includes: i) system indices that include one or more of: instruction counts, a processor cycle, a stall event, and a cache miss event; ii) data generated by one or more hardware counters; and iii) performance information generated at the system-on-chip. The multiple inputs can also include one or more of: i) a first data value indicating one or more software events; ii) a second data value indicating one or more system indices; and iii) a third data value indicating one or more firmware statistics.

Another aspect of the subject matter described in this specification can be embodied in a special-purpose system-on-chip (SoC). The special-purpose SoC includes a processing device; a power manager comprising at least one neural network ML model; and a non-transitory machine-readable storage device storing instructions that are executable by the processing device to cause performance of various operations. For example, the operations include: obtaining multiple inputs generated by a performance counter of the system-on-chip; determining, by an ML classifier model of the power manager, a workload type in response to processing the multiple inputs based on a clustering algorithm applied to the multiple inputs by the ML classifier model; identifying, based on the workload type, a power hint using a data structure that maps multiple workload types to multiple power hints; and determining, for the power hint, power & performance policy settings for a processor block of the system-on-chip.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system that includes an example ML power manager.

FIG. 2 shows an example system architecture that indicates data routing for different use cases involving the ML power manager of FIG. 1.

FIG. 3 shows an example workload classifier of the ML power manager of FIG. 1.

FIG. 4 shows an example flow for workload classification model training of an ML classifier model.

FIG. 5 shows an example flow for workload-specific power policy optimization via reinforcement learning.

FIG. 6 is an example process for ML-based workload classification and optimized power management using the ML power manager of FIG. 1.

Like reference numbers and designations in the various drawings indicate like elements.

### DETAILED DESCRIPTION

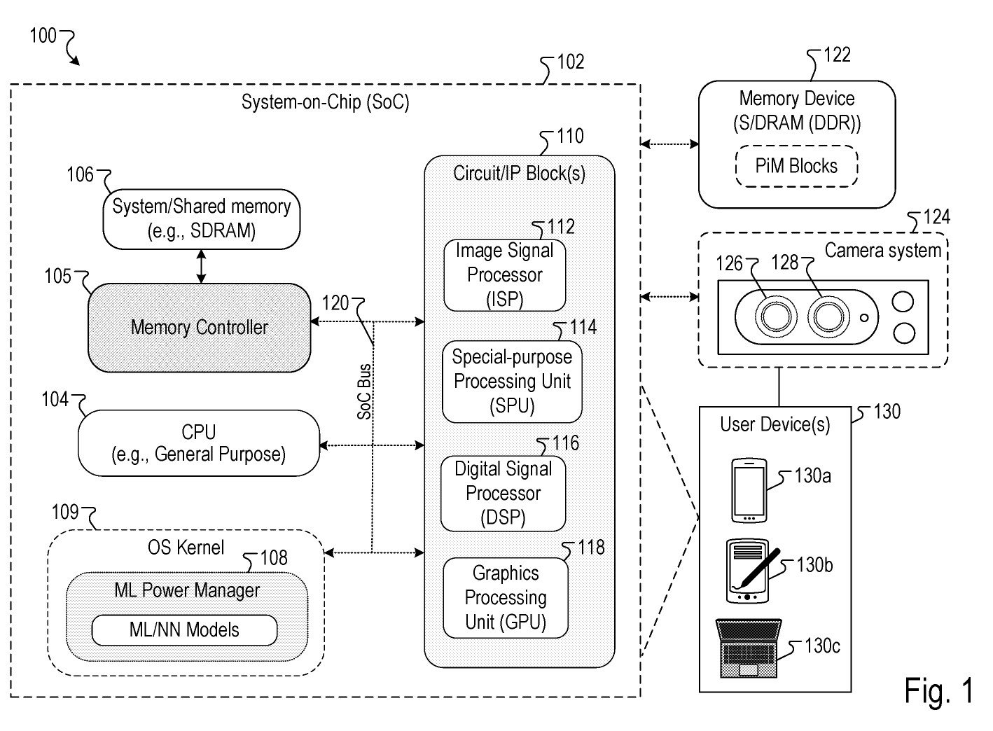

FIG. 1 is a block diagram of an example computing system 100 that includes a system-on-chip 102 (“SoC 102”). The SoC 102 includes a central processing unit 104 (“CPU 104”), a memory controller 105, a shared memory 106 (“memory 106”), an operating system (“OS”) kernel 108, and an IP/circuit block 110. In some implementations, system 100 can include multiple SoCs and descriptions for the SoC 102 will apply equally to each of the multiple SoCs that may be included at system 100.

The CPU 104 can be a general-purpose CPU (e.g., a single or multi-core CPU). The CPU 104 generates one or more indicators, such as an app-launch indicator or a function call that is triggered in response to executing or launching an application at a user device. For example, the application can be a camera application that uses an image sensor to generate image data. In some implementations, the application is configured to request the camera application to obtain image or video content that can be rendered or edited in a user interface generated using the application. The application can request memory and image/graphics processing resources to modify and/or render image content associated with the application. The CPU 104 also generates one or more application values, such as pixel values or frame rate information, including frames per second (FPS). The application values may be associated with a function call, may be descriptive of an event that occurs during execution of the application, or both.

The memory 106 is a system memory, shared memory, or both. In the example of FIG. 1, memory 106 is depicted external to circuit block 110. However, memory 106 can include portions of memory that are: i) specific to circuit block 110, ii) external to circuit block 110, or iii) both. The memory 106 can be a shared random access memory resource of the SoC 102, such as static random-access memory (SRAM). In some implementations, aspects of memory 106 are configured as a shared scratchpad memory that supports parallel access of its memory resources by two or more processors of the circuit 110. The memory 106 can also include various other types of memory, such as high bandwidth memory (HBM).

The OS kernel 108 is a core control interface between example hardware and software layers of system 100. The OS kernel 108 is instantiated in firmware and/or software, and its corresponding program code can be stored in a main memory of CPU 104. In some implementations, the OS kernel 108 is a core program of the OS that enables and/or allows the OS to concurrently manage and control different hardware and software components of system 100. For example, the OS kernel 108 can enable interactions between software and hardware components of system 100, including input/output (I/O) devices and connections, CPU 104 and cache usage, device drivers, file systems, and network sockets.

In the example of FIG. 1, the OS kernel 108 includes an ML power manager 109 that implements ML models for more efficient, granular control of power and/or DVFS settings of system 100 and in particular at SoC 102. The ML power manager 109, including its associated control logic, is implemented in hardware, software, or both. For example, the ML power manager 109 can include resources such as flip-flops, registers, buffers, etc. that are implemented in hardware and control logic (e.g., programmed code) that is implemented in software. Aspects of the ML power manager 109 can be also implemented as firmware of the SoC 102 or firmware of a device of the SoC 102, such as the CPU 104, a special-purpose processor of the IP/circuit block 110, or both.

The circuit block 110 generally includes individual IP devices such as processors, processor cores, or special-purpose processing devices. For example, the circuit block 110 can include an image signal processor (ISP) 112, a special-purpose (SP) processor 114, a digital signal processor (DSP) 116, and a graphics processing unit (GPU) 118. The SP processor 114 can include one or more processing units/devices and is referred to alternatively as an SP processing unit 114 (“SPU 114”). The circuit block 110 is referred to alternatively as an IP block 110, where the IP block can include one or more proprietary hardware elements. For example, each of the ISP 112, SP processor 114, DSP 116, and GPU 118 can be a respective proprietary IP block (or IP device) of a particular entity or device manufacturer.

The SP processor 114 is an ML hardware accelerator, a neural network (NN) processor, or a related processor that is designed and optimized for implementing and/or executing ML models for computing inferences in an edge device. In some implementations, the SP processor 114 (or SPU 114) is a tensor processing unit (“TPU”) that includes a hardware architecture optimized for traversing tensors or other multidimensional constructs to process inputs through neural network layers, using a corresponding set of parameters or kernel filter of weights for the neural network layers. An example hardware architecture for such a SP processor 114 (or TPU) is described in US Pat. No. 10,175,980 B2, which is incorporated by reference herein in its entirety.

In some implementations, aspects of the ML power manager 109 are implemented as a software routine (or module) of the SP processor 114. In some examples, those aspects can be also implemented as a software routine of CPU 104, using one or more hardware resources of the CPU 104, such as registers, buffers, etc. The SP processor 114 can be configured as an instruction and vector data processing engine that processes data obtained from a system memory of the SoC 102, such as memory 106. In some implementations, the ISP 112 and the SP processor 114 are the same device, integrated in a single device package, or both. In other implementations, the ISP 112 and SP processor 114 are distinct devices formed on distinct dies within the same integrated circuit package or within the different integrated circuit packages.

Each processor, e.g., ISP 112, DSP 116, SPU 114, GPU 118, of the SoC 102 can include multiple cores. The OS kernel 108, memory controller 105, and/or CPU 104 can generate control signaling to manage and distribute memory intensive compute operations to a memory device 122 (e.g., DRAM), for example, to minimize the processing load at each core of the processors. The OS kernel 108, memory controller 105, and/or CPU 104 can generate control signaling to manage and distribute operations in accordance with a global power policy, for example, to achieve a particular performance requirement, power consumption threshold, or both. The control signaling is routed at system 100 using an example bus 120 of the SoC 102. The control signaling can include commands, requests, data, instructions, or combination of these.

The OS kernel 108 and ML power manager 109 cooperates with at least the SP processor 114, and in some cases the CPU 104 and other devices of IP block 110, to implement ML-based workload classification and power management optimizations in real-time. More specifically, the ML power manager 109, in cooperation with the OS kernel 108, is configured to generate control signaling to configure, manage, and implement global power policies of system 100.

In some implementations, the operations are executed at the SoC 102 in support of a heterogeneous compute operation between two or more processing units that are included among the IP block 110, the CPU 104, or both. For example, the heterogeneous compute operation can be between the ISP 112 and the SP processor 114. The ML power manager 109 implements its power management operations using ML models, including one or more neural network ML models.

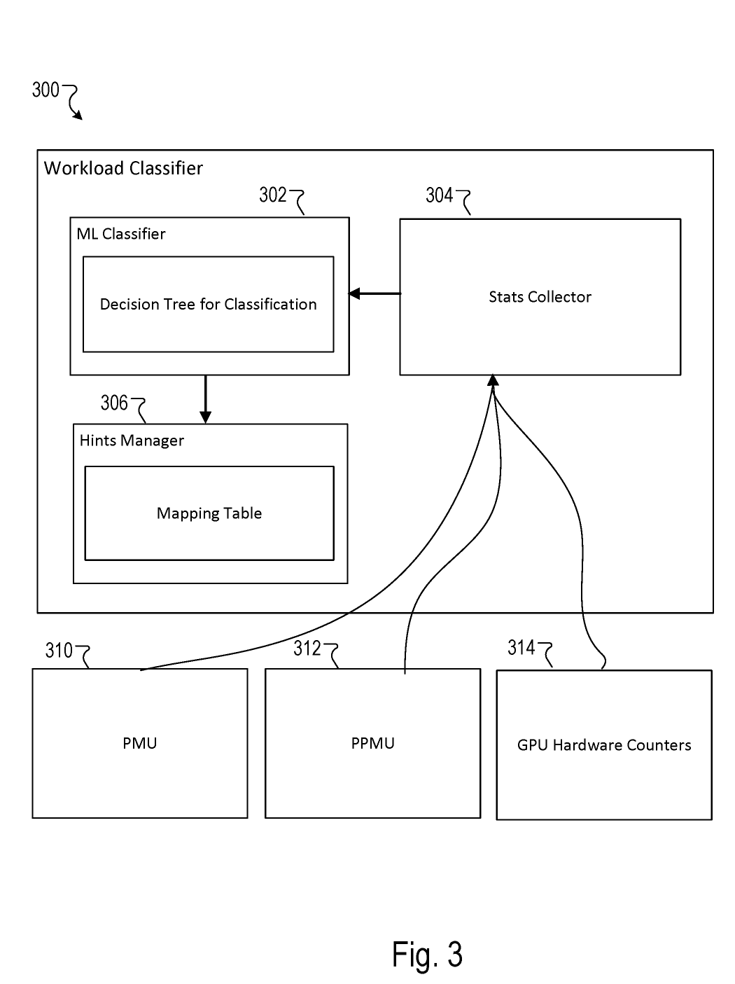

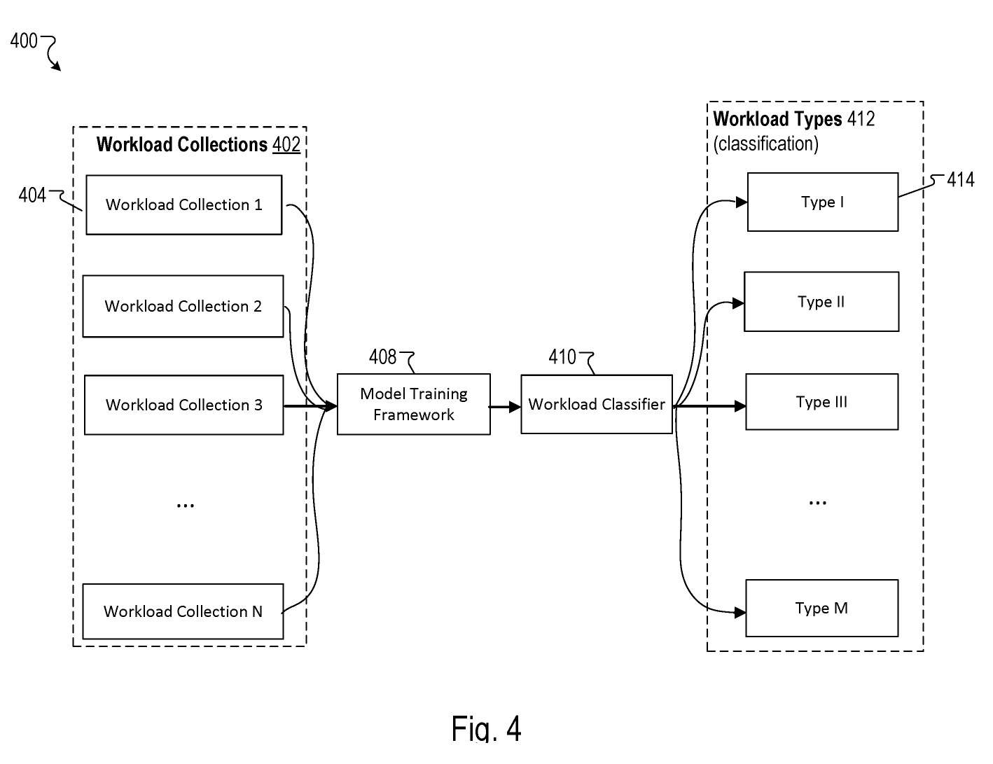

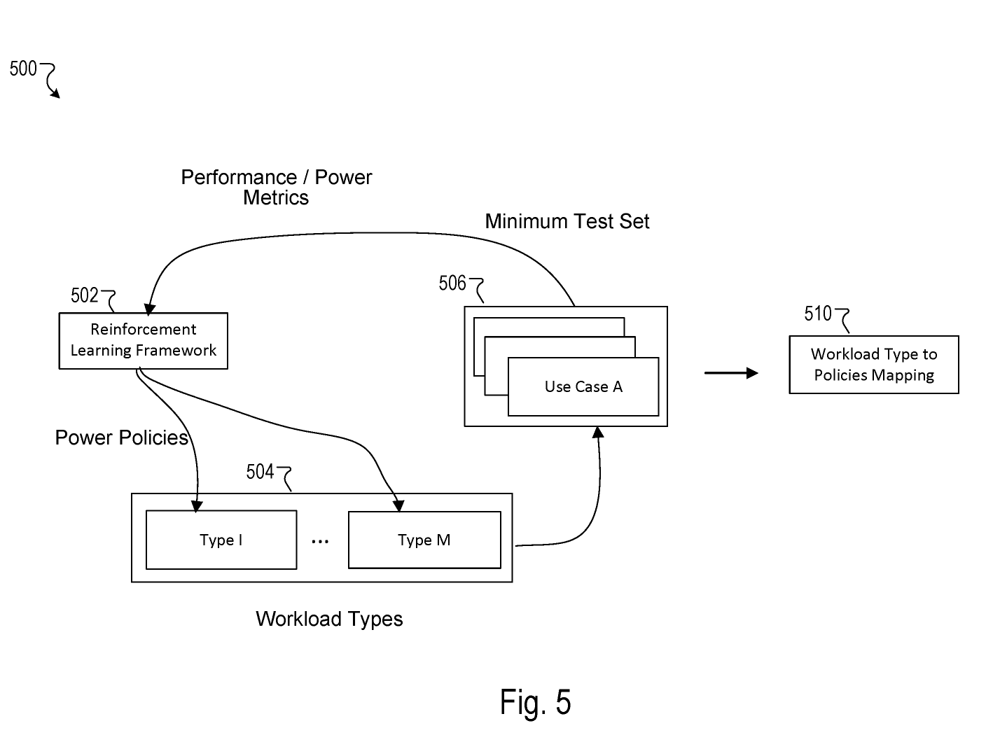

For example, the ML power manager 109 is configured to implement an ML workload classifier model and a power optimization ML model. Each of the ML workload classifier model and power optimization ML model can be neural network ML models that are implemented at the SoC 102 using the SP processor 114. The ML workload classifier model is described below with reference to FIG. 3 and FIG. 4, whereas the power optimization ML model is described below with reference to FIG. 5.

In some implementations, system 100 includes an example memory device 122. The memory device 122 can be a dynamic random-access memory (DRAM) or Double Data Rate (DDR) synchronous DRAM (SDRAM). The memory device 122 is configured to perform or support various types of processor-in-memory (“PiM”) operations, compute-in-memory (“CiM”) operations, and memory-near-computing operations (“MnC”) operations. The memory device 122 performs or supports these operations using its multiple PiM compute blocks.

The PiM, CiM, MnC operations include standard arithmetic operations, such as computations normally performed by an ALU or MAC. For example, these operations can also include computational functions of a SPU 114, such as multiplication and addition operations for matrix math, vector computations, linear algebra, and dot-product accumulations. In some implementations, each of the PiM operations, CiM operations, and MnC operations are performed in support of machine-learning computations, neural network computations, or both. Example PiM, CiM, and MnC operations can also include standard CPU functions involving instruction processing, handling interrupts, and managing branching and pointer operations.

The SoC 102 cooperates with the memory device 122 to perform data storage and PiM/CiM computations across one or more memory die of the memory device 122. As indicated above, the computations can be for heterogeneous operations or machine-learning workloads that involve one or more of the processors at IP block 110. In at least one example the memory device 122 may be external to the SoC 102, whereas in another example the memory device 122 may be internal to the SoC 102.

The system 100 includes a multi-camera system 124. The multi-camera system 124 includes at least a first camera 126 having a wide-angle (or ultra-wide angle) lens for capturing image content within a first FOV and a second, different camera 128 having a telephoto lens for capturing image content within a second, different FOV. The second FOV of the second camera 128 is narrower than the first FOV of the first camera 126. System 100 is configured to fuse images captured by the different cameras of the multi-camera system 124. In some implementations, the first camera 126 can be described as a wide-angle camera (W), whereas the second camera 128 can be described as a telescope camera (T).

In the example of FIG. 1, the multi-camera system 124 is integrated in an example edge device, such as client/mobile device 130 (described below). In particular, the multi-camera system 124 can be an example camera system of a modern, mobile smartphone, which is a well-known hardware feature of an edge device. In some implementations, the multi-camera system 124 includes a time-of-flight (ToF) sensor that enhances image capture performance of the multi-camera system 124. For example, the image capture performance is enhanced under ambient light conditions, but with reduced power consumption relative to multi-camera systems that do not include a ToF sensor.

In the example of FIG. 1, the system 100 and the SoC 102 is an integrated circuit of an example user/client device 130, consumer electronic device, or mobile device, where each of these devices can include items such as a smartphone 130a, a tablet 130b, a laptop 130c, and a wearable device. The devices 130 may also include other items such as an eNotebook, Netbook, and/or related mobile computing devices, including aerial drones and other autonomous vehicles, automobiles, self-driving cars, and systems for autonomous vehicle controls.

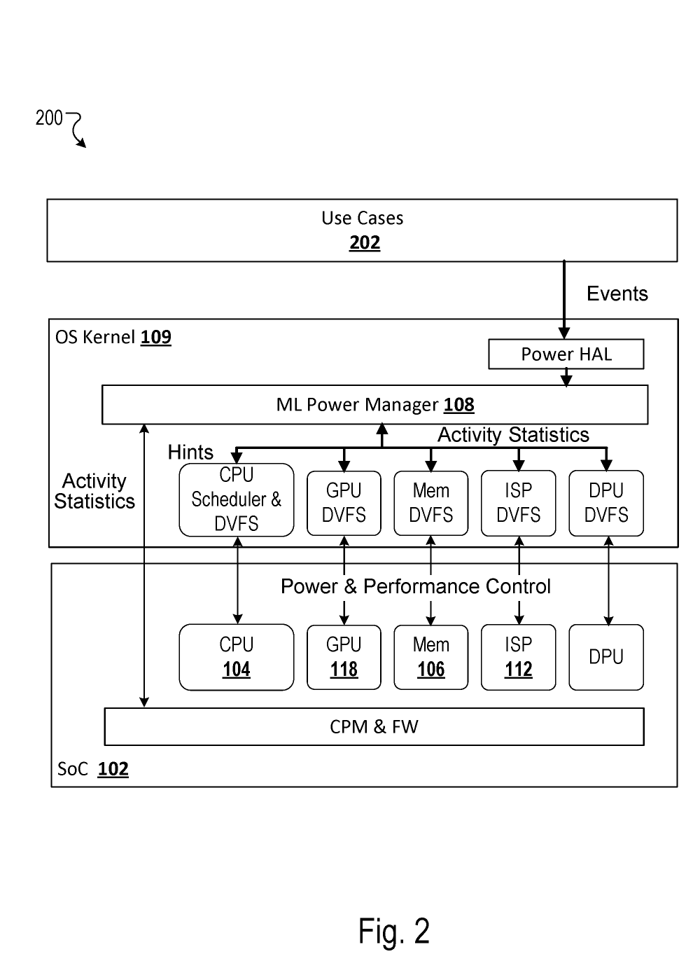

FIG. 2 shows an example system architecture 200 that indicates data routing for different use cases involving the ML power manager of FIG. 1.

The system architecture 200 can be used for different use cases 202 that may be implemented or encountered on a client/mobile device 130. Based on different use cases 202, a ML power manager 109 can receive data corresponding to specific events for each of the use cases 202. For example, the use case 202 can be real-time navigation on the mobile device 130. In this example, the events can include opening a navigation app, determining the device’s location, rendering the map on the screen, etc. In some implementations, the events are global SoC events that are generated when executing an application program for a given use case 202.

The ML power manager 109 can be configured as a module of OS kernel 108 that is designed to achieve the shortest latency and minimal resource overhead when retrieving required inputs for determining SoC power & performance policy settings and managing other power subsystems. The ML power manager 109 can include a machine-learning based workload classifier as the governor of the power management processes implemented at the SoC 102. The workload classifier is described in more detail below with reference to FIG. 3 and FIG. 4.

In addition to receiving the use cases 202 and data representing events associated with each use case 202, the ML power manager 109 can also receive activity statistics about the use case 202. For example, the ML power manager 109 can receive activity statistics from other components of system 100 that communicate with the OS kernel 108, as well as from a chip power model (CPM) and firmware of the SoC 102.

In some implementations, the CPM is a model used to estimate and manage power consumption of a chip or IP block of the SoC 102. The activity statistics can include software events, system indices, low-level firmware stats, and workloads. As a particular example, software events can include SystemServer, Framework, or App events. As another example, system indices can include CPU/GPU/MIF frequency or active ratio. As a particular example, low-level firmware stats can include metrics from the performance monitoring unit (PMU), platform performance measuring unit (PPMU), and/or GPU hardware counters.

The ML power manager 109 can then use the activity statistics for the use case 202 as input data that is processed to classify workloads for a given use case and to enhance or optimize power management decisions at the SoC 102. By receiving activity statistics from both the OS kernel 108 and firmware of the SoC 102, the ML power manager 109 determines power & performance policy settings and DVFS control values based on a global view of system 100, further optimizing power management within the system 100. Workload classification using the ML power manager is described in more detail below with reference to FIG. 3 and FIG. 4.

The ML power manager 109 is configured to generate power hints based on the use cases 202 and the activity statistics of the system when implementing a given use case. In some implementations, the power hints are provided as inputs to one or more kernel components, such as the CPU scheduler & dynamic voltage and frequency scaling (DVFS), the GPU DVFS, the memory DVFS, the ISP DVFS, and the DPU DVFS. In some implementations, power hints represent predefined power & performance policy settings for specific events, such as a camera shot event or a gaming event.

The ML power manager 109 can generate these power hints to improve power management within the system by influencing the power & performance policy settings of processors for specific events. For example, for rendering the map on the screen during a navigation use case, a power hint can be generated for the graphics processing unit (GPU) that gives a predefined optimized power setting that best balances power efficiency and performance output.

For example, the power hint can indicate, to each of the DVFS modules, a threshold voltage and frequency that optimizes performance concurrent with improving overall power management and power allocation at the SoC 102. In this particular example, the power hint can influence the GPU DVFS to increase power to a certain amount to the GPU to achieve a threshold rendering speed or frame rate for rendering the graphics of the map. The DVFS settings are used to dynamically adjust voltage and frequency of a processor, and each DVFS can use these power hints to best adjust frequencies for optimized power efficiency and performance for a specific processor. In some implementations, each processor of the SoC can implement its own respective DVFS control to allow for more granular control over power consumption at that processor and in a manner that improves overall power management at system 100.

FIG. 3 shows an example workload classifier of the ML power manager described above with reference to FIG. 2. The workload classifier 300 is designed to dynamically optimize power policies based on real-time system metrics collected through various hardware counters. The workload classifier 300 can include a stats collector 304, a ML classifier 302, and a hint manager 306. The workload classifier 300 can be implemented in hardware and software. For example, some aspects of the workload classifier 300 can be implemented in software, whereas other aspects of the workload classifier 300 can be implemented in hardware.

The stats collector 304 is configured to collect real time system metrics. For example, the stats collector 304 can collect low level system indices, including instructions counts, CPU cycles, IPC, stalls and L3 cache misses from the performance monitoring unit (PMU) 310. In some implementations, the stats collector 304 can be integrated with a platform performance measuring unit (PPMU) 312 and other hardware counters, e.g., a GPU hardware counter 314, to enhance data collection with additional performance metrics. That is, the stats collector 304 can collect additional metrics to be analyzed through the PPMU and other hardware counters.

The ML classifier 302 can then classify workloads based on the collected metrics from the stats collector 304. The ML classifier 302 can utilize a decision tree to classify workloads. The decision tree can be offline trained, which is described in further detail with reference to FIG. 4. The ML classifier 302 can then determine appropriate power management strategies based on the categorized workload.

The hint manager 306 is configured to generate and/or maintain a workload-to-hint mapping table 308. The hint manager 306 uses the workload-to-hint mapping table 308 to map the classified workloads to specific power management hints known as PowerHints. A PowerHint can be a software hint that predefines power & performance policy settings for specific use cases, e.g., camera shot, gaming. Each of the PowerHints can have a corresponding set of power & performance policy settings and/or performance settings that are triggered at the SoC based on a specific workload type. The PowerHints can be used to then pass power & performance policy settings, e.g., DVFS settings, to the kernel to influence the CPU scheduler and other governors, e.g., DVFS modules.

In some implementations, the PowerHints can be represented as uclamp_min values in the workload-to-hint mapping table 308. Uclamp_min values can set the lower bound of performance requirements for a particular task. That is, uclamp_min can tell the CPU scheduler the minimum performance point to operate at to deliver the desired user experience for a particular task. In this implementation, the table maps specific values to uclamp_min values to optimize power management.

In some implementations, the workload-to-hint mapping table 308 can support additional tunables for a more comprehensive optimization strategy. In this specification, power/performance/DVFS settings may also be referred to as a global power policy that corresponds to a particular PowerHint. That is, the workload type to PowerHint mapping table can determine the power policy to implement within the SoC.

The workload type to PowerHint mapping table is a data structure that maps specific workload types to specific PowerHints. The hint manager 306 can apply these hints to adjust system parameters, including CPU frequency, thread scheduling and power states. The workload-to-hint mapping table 308 can be trained offline to optimize the mapping of PowerHints to workload type. The workload-to-hint mapping table is described in further detail with reference to FIG. 5.

The workload classifier 300 can then select a particular PowerHint based on the workload type by reading the optimized workload-to-PowerHint mapping table. The workload classifier can then adjust power & performance policy settings, e.g., DVFS settings, based on the given PowerHint to implement a particular global power policy. Essentially, the workload classifier 300 can provide more adaptive real-time classification and power management by dynamically adjusting power & performance policy settings based on classified workloads and optimized PowerHints.

FIG. 4 shows an example flow for workload classification model training of an ML classifier model. More specifically, workload classification model training is a methodology to train a machine learning model for workload classification.

To begin, one or more workload collections 402 are gathered. A workload collection, e.g., workload collection 404, is a dataset including system indices, software events, firmware states and various PMU counter metrics, e.g., instructions, cycles, IPC, stalls, cache misses and other relevant metrics. The metrics can be captured under different operating conditions and use cases and each workload collection of the one or more workload collections 402 represents different types of system workloads. For example, workload collection 404 can represent a web browsing workload. Other workload collections can represent any appropriate workload for a SoC for a user/client device, including but not limited to, streaming video, gaming, voice calls, navigation, or music playback.

The model training framework 408 can then receive the one or more workload collections 402. The model training framework 408 can train the workload classifier model 410 to categorize the one or more workloads 402 into workload classification types 412. The model training framework 408 can train the workload classifier 410 using machine learning techniques, e.g., unsupervised, or supervised learning.

In some implementations, the model training framework 408 can use unsupervised learning to train the workload classifier 410. For example, the model training framework 408 can use k-means clustering to identify patterns in the one or more workloads 402 and group the workloads into N clusters, or M workload types. K-means clustering works by randomly selecting K initial centroids and then assigning each data point to the nearest centroid, forming clusters. In some implementations, the “nearest” centroid can be calculated based on Euclidean distance. The centroids are recalculated throughout assignment as the mean of the data points in each cluster.

In this specific example, each cluster represents a distinct type of workload characterized by specific system behaviors and resource demands. That is, the one or more workload collections 402 are assigned to a specific workload cluster based on similar features of the workload collection. For example, the workload collections 402 can be clustered based on instructions per cycle (IPC), IPC time variance, memory frequency and GPU workload. By using k-means clustering, the model training framework 408 can group workloads with similar features together into N clusters, or M workload classification types 412. Basing classification types 412 on features versus more general workload type, e.g., gaming, the workload collections 402 are being analyzed and classified more granularly, allowing for more effective optimization and improved power management. For example, not all gaming workloads are the same and should not be classified in the same way. The approach described in this specification considers this fact and focuses classification more on system behaviors and resource demands as described above, leading to more accurate and optimized classifications for later power policy management.

In some implementations, the workload classifier 410 can be trained using supervised learning. For example, the workload classifier 410 can be trained using logistic regression or a k-nearest neighbors (KNN) algorithm. The workload classifier 410 is not restricted to these methods and can be trained using any appropriate supervised learning method. The model training framework 408 can then output a machine learning model, e.g., the workload classifier 410, that encapsulates the classification types 412 and serves as the basis for classifying workloads in real time.

The workload classifier 410 can be converted from the workload classification types 412 to a decision tree structure. A decision tree is a machine learning model that is configured to classify data using decisions based on features of the data. Each internal node represents a decision based on a feature and each leaf node represents a final classification type. Essentially, data moves through the tree based on decisions, e.g., move to the left branch of the tree if it has that feature or to the right branch of the tree if it does not have that feature, and eventually, ends up at a leaf node with a final classification based on the feature decisions. For example, as described above, instructions per cycle can be a feature that influences the classification of the workloads. In this specific example, the decision at a node could be if the workload has an IPC above 400 or below 400, e.g., move to the left branch if IPC is above 400 or move to the right branch if IPC is below 400.

For example, in the k-means clustering example, the workload collections 402 are partitioned into N clusters, or M workload classification types 412. As described above, each workload collection 404 is assigned to a cluster based on similar features. The decision tree can then be trained based on the classification types 412, the features associated with those classification types and the workloads 402 that are clustered in the classification type. The decision tree can then learn to predict the classification type 414 of the workload collection 404 input based on the features. The resulting decision tree can then be used to classify new workload collections 402 into the predefined workload classification types 412.

The decision tree can be coded in C to ensure seamless integration with the system’s kernel modules, allowing real time workload classification during system operation.

The decision tree within the workload classifier 410 can then be used to classify the workload collections 402 into workload classification types 412. The workload classification types 412 can range from 1 to N different types. As described above, the workload classification types 412 are based on similar features of the workload collections 402. For example, a workload collection 404 can be collected by the model training framework 408 and classified as type I 414 based on the workload classifier 410.

In the k-means clustering implementation, the workload classification types 412 are clustered based on a variety of features of the workload collections 402 and the types 412 may not have a distinct meaning. For example, type I 414 may not necessarily be workloads that have an IPC of 300. The workload classification types 412 are clustered by similar features, but the clustering may not have an explicit meaning that is understandable by humans the same way it is understandable to the machine learning model.

FIG. 5 shows an example flow for workload-specific power policy optimization via reinforcement learning.

The workload specific power policy optimization via reinforcement learning is a methodology that uses reinforcement learning to determine a potentially optimal mapping of PowerHints to workload classification types, e.g., the workload classification types 504. The reinforcement learning framework 502 can be used to generate a workload type to PowerHint mapping table. As an example, the PowerHints can be represented as uclamp_min values and a workload type to uclamp_min mapping table can be used to optimize power management.

The process 500 starts with a minimum test set 506 that represents a set of benchmark use cases, each representing real world workloads. The minimum test set 506 can be run by an auto test infrastructure that evaluates the system’s performance under different PowerHint mapping configurations. The reinforcement learning framework 502 can generate various mapping tables where, in each mapping table, potential workload types are mapped to PowerHints. The mapping tables are used to propose different PowerHint mapping configurations for implementing different power management approaches across the SoC. A test cycle can include testing one or more use cases against different mapping tables to evaluate performance within system 100 for different hints and corresponding power settings of a mapping table. In some implementations, one test cycle includes testing use cases in a test set of use cases 506 on a current mapping table, as well as on various other potential mapping tables, to evaluate performance within system 100.

Each use case in the test set 506 is run to collect data on system behavior, including power consumption and performance metrics for a PowerHint mapping configuration. That is, a current mapping table is compared to different potential mapping tables created by the framework 502 based on their effectiveness in terms of power consumption, latency, jank, and other relevant metrics for the given use case. The cycle then repeats for each use case in the test set of use cases 506.

In some implementations, to reduce the complexity of testing, only one workload type is boosted in each mapping table. For example, with one hint, uclamp_min can be boosted to 500 and 10 workload types, to end up with 10 mapping tables in total. The process 500 then uses the collected performance and power metrics and a reinforcement learning framework 502 to determine the optimal power policies, e.g., PowerHints, for each workload type 504 based on the use case. For example, use case A is tested to collect the performance power metrics for each of the potential mapping tables created.

The reinforcement learning framework 502 can receive the metrics and analyze the data to assess the current PowerHint settings. The reinforcement learning framework 502 can then adjust the PowerHint mappings in the current workload type to PowerHints mapping table 510 based on the performance feedback from the other potential mapping tables to improve both performance and power efficiency of power policies.

The reinforcement learning framework 502 can use reinforcement learning techniques to adjust the PowerHints and generate the potentially optimal workload type to PowerHint mapping table, learning from each test cycle to enhance system optimization. For example, the reinforcement learning framework 502 can perform the mapping based on a particular reward function. The reward function can be tied to a minimum power and/or frequency needed to achieve a certain expected performance for a given workload classification type 504. For example, the reward functions can be tied to certain values of frames per second (FPS), power consumption, jank and latency for each type of workload. As a particular example, the reward function can be tied to finding the optimal PowerHint for a certain FPS value, meaning that the reward function is looking to find the PowerHint with the minimum power and/or frequency needed to achieve an expected frames per second (FPS).

To optimize the given reward function, e.g., FPS, the reinforcement learning framework can receive performance and power metrics based on the current power hint settings and can update the power hint settings based on the current value of the reward function. The reinforcement learning framework 502 can then learn from the updates to see which settings yield the best power optimization for certain workload classification types 504 when creating the various potential mapping tables to test in the next test cycle. The framework 502 balances exploration, e.g., trying new power hint settings, and exploitation, e.g., using known good settings. For example, the reinforcement learning framework 502 can adjust a power hint to map to workload type I and see that it does not optimize power. The reinforcement learning framework 502 can then adjust workload type I to map to another hint as well as learn that the adjustment led to worse power optimization to avoid that in the future. As another example, the reinforcement learning framework 502 can map a hint to workload type I and see that the performance / power metrics are improved and continue to adjust the mappings to further optimize.

The workload specific power policy optimization via reinforcement learning can iteratively refine the PowerHints in every test cycle to optimize system performance and power efficiency.

After a cycle occurs, the optimized global power policy, e.g., power and performance settings, for each workload type is determined based on the optimized hints. More specifically, the reinforcement learning framework 502 has generated a potentially optimal workload type 504 to PowerHint mapping table. For example, a workload classified as type I is mapped to a specific PowerHint, e.g., PowerHint II. For every workload classified as type I, the PowerHint will be the same, PowerHint II in the given example.

As described above with reference to FIG. 3, each of the PowerHints has a corresponding set of power / performance / DVFS settings that can be triggered in the SoC based on a particular workload type. Thus, the global power policy can be determined based on the workload type through the mapping of the workload type to an optimized PowerHint that corresponds to specific power & performance policy settings within the SoC.

To evaluate other mappings for a subsequent test cycle, the reinforcement learning framework 502 can generate more potential workload-to-PowerHint mapping tables based on a prior mapping table that was optimized in the previous training iterations. The various workload-to-PowerHint mapping tables are reapplied to the next use case in the minimum test set 506. Essentially, a continuous feedback loop is established where the reinforcement learning framework incrementally improves the power hints based on real word data, optimizing both power efficiency and performance.

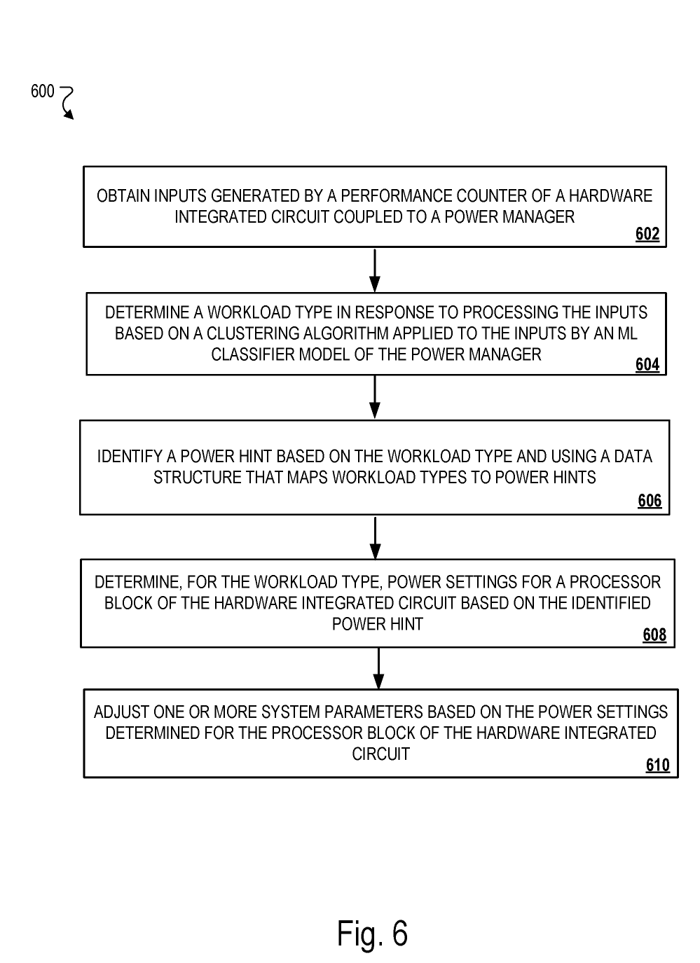

FIG. 6 is an example process 600 for ML-based workload classification and optimized power management using the ML power manager 109. Process 600 is also implemented or executed at system 100 using at least the OS kernel 108 and/or ML power manager 109 described above with reference to FIG. 1. Hence, descriptions of process 600 will reference the above-mentioned computing resources of system 100. In some examples, the steps or actions of process 600 are enabled by programmed software instructions, firmware instructions, or both. Each type of instruction may be stored in a non-transitory machine-readable storage device and is executable by one or more of the processors or other resources described in this specification.

Referring again to process 600, the system 100 obtains inputs that are generated by a performance counter of a system-on-chip coupled to the power manager (602). The system 100 determines a workload type in response to processing the inputs based on a clustering algorithm applied to the inputs by the ML classifier model of the ML power manager 109 (604). The system 100 identifies a power hint based on the workload type (606). For example, the ML power manager 109 can identify the power hint using a data structure that maps different workload types to different power hints.

For the particular workload type, system 100 is configured to determine power & performance policy settings at the system-on-chip based on the identified power hint mapped to that particular workload type (608). For example, the ML power manager 109 can determine power & performance policy settings for a specific processor block or multiple IP blocks of the system-on-chip based on the identified power hint. The system 100 adjusts one or more system parameters based on the power & performance policy settings determined for the processor block of the system-on-chip (610). For example, the system 100 uses the ML power manager 109 to execute any required adjustments of a given power setting to implement a particular global power policy that corresponds to the identified power hint.

In some implementations, the respective steps of process 600 are performed at a system-on-chip as part of a larger compute operation to generate a machine-learning (ML) output, including an output for a neural network layer of a neural network that implements one or more ML models. For example, the output can be a portion of a computation for a ML task or inference workload to generate an image processing, speech processing, or image recognition output. As indicated above, a portion of the integrated circuit can include a special-purpose inference processor, such as a neural network processor or hardware ML accelerator, configured to accelerate computations for generating different types of data processing outputs.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed using a power manager comprising one or more neural network machine-learning (ML) models, the method comprising:
obtaining a plurality of inputs generated by a performance counter of a system-on-chip coupled to the power manager;
determining, by an ML classifier model of the power manager, a workload type in response to processing the plurality of inputs based on a clustering algorithm applied to the plurality of inputs by the ML classifier model;
identifying, based on the workload type, a power hint using a data structure that maps a plurality of workload types to a plurality of power hints; and
determining, for the power hint, power & performance policy settings for a processor block of the system-on-chip.

2. The method of claim 1, further comprising:
adjusting one or more system parameters based on the power & performance policy settings determined for the processor block of the system-on-chip.

3. The method of claim 2, further comprising:
generating the data structure based on machine-learning computations executed by a reinforcement learning model of the power manager,
wherein the data structure maps the plurality of workload types to the plurality of power hints based on a reward function that optimizes respective power & performance policy settings for each of the plurality of power hints.

4. The method of claim 3, wherein each of the plurality of power hints is mapped to a corresponding set of power & performance policy settings that represent a global power policy for a corresponding workload type.

5. The method of claim 1, wherein the clustering algorithm is an unsupervised K-means clustering algorithm.

6. The method of claim 1, wherein the clustering algorithm is a supervised K-means clustering algorithm.

7. The method of claim 6, further comprising:
training the ML classifier model based on a K-means clustering algorithm during a training phase of the ML classifier model;
identifying, during the training phase, a plurality of distinct patterns among multiple datasets that represent different workloads processed at a system-on-chip; and
generating, during the training phase, N clusters of workloads based on the identified plurality of distinct patterns.

8. The method of claim 7, wherein each cluster of the N clusters comprises a respective subset of workloads that are among the different workloads represented by the multiple datasets.

9. The method of claim 1, wherein the plurality of inputs comprises:
i) system indices that include one or more of: instruction counts, a processor cycle, a stall event, and a cache miss event;
ii) data generated by one or more hardware counters; and
iii) performance information generated at the system-on-chip.

10. The method of claim 1, wherein the plurality of inputs comprises one or more of:
i) a first data value indicating one or more software events;
ii) a second data value indicating one or more system indices; and
iii) a third data value indicating one or more firmware statistics.

11. A special-purpose system-on-chip comprising:
a processing device;
a power manager comprising at least one neural network ML model; and
a non-transitory machine-readable storage device storing instructions that are executable by the processing device to cause performance of operations comprising:
obtaining a plurality of inputs generated by a performance counter of the system-on-chip;
determining, by an ML classifier model of the power manager, a workload type in response to processing the plurality of inputs based on a clustering algorithm applied to the plurality of inputs by the ML classifier model;
identifying, based on the workload type, a power hint using a data structure that maps a plurality of workload types to a plurality of power hints; and
determining, for the power hint, power & performance policy settings for a processor block of the system-on-chip.

12. The system-on-chip of claim 11, wherein the operations further comprise:
adjusting one or more system parameters based on the power & performance policy settings determined for the processor block of the system-on-chip.

13. The system-on-chip of claim 12, wherein the operations further comprise:
generating the data structure based on machine-learning computations executed by a reinforcement learning model of the power manager,
wherein the data structure maps the plurality of workload types to the plurality of power hints based on a reward function that optimizes respective power & performance policy settings for each of the plurality of power hints.

14. The system-on-chip of claim 13, wherein each of the plurality of power hints is mapped to a corresponding set of power & performance policy settings that represent a global power policy for a corresponding workload type.

15. The system-on-chip of claim 11, wherein the clustering algorithm is an unsupervised K-means clustering algorithm.

16. The system-on-chip of claim 11, wherein the clustering algorithm is a supervised K-means clustering algorithm.

17. The system-on-chip of claim 16, wherein the operations further comprise:
training the ML classifier model based on a K-means clustering algorithm during a training phase of the ML classifier model;
identifying, during the training phase, a plurality of distinct patterns among multiple datasets that represent different workloads processed at a system-on-chip; and
generating, during the training phase, N clusters of workloads based on the identified plurality of distinct patterns.

18. The system-on-chip of claim 17, wherein each cluster of the N clusters comprises a respective subset of workloads that are among the different workloads represented by the multiple datasets.

19. The system-on-chip of claim 11, wherein the plurality of inputs comprises:
i) system indices that include one or more of: instruction counts, a processor cycle, a stall event, and a cache miss event;
ii) data generated by one or more hardware counters; and
iii) performance information generated at the system-on-chip.

20. A non-transitory machine-readable storage device storing instructions for a implementing a power manager implemented on a special-purpose system-on-chip, the power manager comprising at least one neural network ML model, and the instructions being executable by a processing device to cause performance of operations comprising:
obtaining a plurality of inputs generated by a performance counter of the system-on-chip;
determining, by an ML classifier model of the power manager, a workload type in response to processing the plurality of inputs based on a clustering algorithm applied to the plurality of inputs by the ML classifier model;
identifying, based on the workload type, a power hint using a data structure that maps a plurality of workload types to a plurality of power hints; and
determining, for the workload type, power & performance policy settings for a processor block of the system-on-chip based on the identified power hint.
